(19) United States
(12) Patent Application Publication
(10) Pub. No.: US 2005/0238955 A1
(43) Pub. Date: Oct. 27, 2005

(54) Battery and battery terminal structure and method of manufacture

(76) Inventors: John Willard Hooke, Ozark, MO (US); Frank Albert Fleming, Ozark, MO (US)

Correspondence Address: THOMPSON COBURN, LLP, ONE US BANK PLAZA, SUITE 3500, ST LOUIS, MO, 63101, US

(21) Appl. No.: 10/832,079

(22) Filed: Apr. 26, 2004

(51) Int. Cl. H01M 2/30; H01M 2/04; H01M 2/06; H01M 2/08

(52) U.S. Cl. 429/181; 29/623.2; 429/175; 429/183; 429/184

(57) ABSTRACT

The construction of an electrically conductive terminal of a lead-acid battery seals a terminal post from the acid in the battery box interior by an collar that is mounted on the exterior of the terminal and that sandwiches a seal between the collar and a plate strap of the battery in the interior of the battery box. The collar is sealed to the battery casing.

### BACKGROUND OF THE INVENTION

(1) Field of the Invention

The present invention is directed to a battery construction and method of manufacture, and more particularly a terminal structure for a lead-acid battery that provides improved sealing that prevents the acid within the battery from leaking from the battery casing and from contacting the terminal.

(2) Description of the Related Art

In the design of lead-acid batteries, i.e. batteries having a plurality of lead or lead alloy plates in a solution of sulfuric acid, sealing the battery casing and the electrically conductive terminals of the battery are primary considerations. The electrically conductive terminals are often constructed of brass or other similar metal that can react and corrode when exposed to the acid of the battery. The battery acid can also be very destructive and harmful should it leak from the battery casing. It is therefore necessary that the construction of the lead-acid battery insures that no acid leakage occurs and that the terminal post be sealed from the acid contained in the battery casing.

In the constructions of prior art lead-acid batteries, the lead or lead alloy plates of the battery and the lead or lead alloy plate straps that interconnect the plates typically were enclosed in a casing that was comprised of a battery box and a lid secured over a top opening of the battery box. The lid was provided with terminal openings and the electric terminals of the battery projected upwardly from the plate straps and through the lid openings. A seal was provided around each terminal between an interior surface of the lid and a top surface of the plate strap. A threaded nut was screw threaded on each terminal and against the lid to hold the lid against the seals. The seals were sandwiched between the casing lid and the plate strap, thereby sealing the electric terminal posts from the acid contained in the battery casing.

With such prior art terminal constructions it was difficult to achieve a proper and effective seal against leakage of the battery acid around the terminal post. If the seal was of a type that sealed in a generally axial direction relative to the axis of the terminal post, it was necessary to insure that the post was exactly perpendicular to the lid contact surface with the collar so that upon tightening the collar onto the post the collar applied even and uniform pressure on the lid surface all around the post to thereby apply a uniform force of the lid against the seal. If the post was not perpendicularly oriented relative to the lid surface surrounding the post, the collar applied uneven force to the lid which thereby applied uneven force on the seal causing leakage problems.

Similarly, if the seal was of the type that sealed in a generally radial direction, it was required that the lid and terminal surfaces between which the seal was places be concentric requiring precise concentric alignment of these components which was difficult to achieve. Without precise concentricity, battery acid leakage past the seal could occur.

Other prior art battery structures for lead-acid batteries included a threaded plastic nut or collar mounted on a threaded terminal post that extended through a lid opening. The lid had a shoulder around the opening. The nut was tightened down on the terminal post against the shoulder of the lid to hold the lid against the lead strap at the base of the post or against a seal located between the lid and strap. A seal was disposed between the fastener (nut), lid and terminal. With this structure the nut was mounted to the terminal post after the terminal post was inserted through the opening in the lid. Sufficient torque had to be applied to the nut not only to apply sufficient pressure on the seal, but also to draw the terminal post and the components within the battery case to which the terminal was connected (the lead strap and plates) up against the lid.

### SUMMARY OF THE INVENTION

It was with a view toward solving these problems and generally providing a more reliable and effective battery seal structure that the present invention was made.

The present invention is directed to an improved battery and battery terminal structure that provides superior sealing against leakage and contact of the battery acid with the battery terminal. In accordance with a preferred embodiment of the invention, a seal is provided between a collar that is mounted to the battery terminal and the strap that electrically connects the battery plates within the battery casing. Also preferably, the lid of the casing is structurally sealed to the collar and at least a portion of the collar is positioned within the casing in contact with the acid within the battery. The seal between the collar and strap prevents contact of the battery acid with the terminal post, and prevents leakage of the battery acid past the collar and terminal post to the exterior of the battery casing. The battery terminal of the invention preferably is employed in a lead-acid battery wherein lead or lead alloy plates and acid are contained in a casing comprised of a battery box and a lid that closes over a top opening of the battery box. A plurality of plates of same polarity are connected together by a plate strap within the casing. Each battery terminal is attached to a plate strap and projects upwardly through an opening in the casing lid.

The collar is constructed of a material that is inert to the environment within the battery and that can be secured to the battery lid. Most preferably the terminal material also is electrically non-conductive. The collar may be screw-threaded onto the terminal post to thereby sandwich the seal between the collar and the plate strap.

Further in accordance with a preferred embodiment of the invention, the collar has a cylindrical sleeve that extends around the battery terminal. A top edge of the sleeve is structurally sealed to a surface of the casing lid around the lid opening provided for the terminal. The perimeter of the casing lid is structurally sealed to the top edge of the casing box, thereby sealing the interior of the battery casing. The seal between the collar and the strap, and the seal between the collar and the lid in combination seal the interior of the battery casing from the exterior environment of the battery.

A variety of different seals are provided between the collars and the battery terminals in variant embodiments of the battery terminal construction. In one embodiment, the seal of each terminal is provided by a sealant. As used herein, “sealant” means a material which when applied is in a fluidized condition, and, whether settable or non-settable, has the property of providing an effective seal against leakage of the acid within the battery. In another embodiment the seal is provided by a gasket which may be, but is not required to be, of an elastomeric material, positioned around the terminal and held in compression between the collar and the plate strap. In a further embodiment, the seal is provided by a grommet positioned around the terminal and between the collar and the plate strap. Still further embodiments of the battery terminal structure make use of combinations of sealants, gaskets, and grommets in providing the seal between the collar and the plate strap.

The present invention also is directed to a method of constructing a battery and battery terminal wherein the collar is mounted to the battery terminal after the seal is placed around the terminal post. In one preferred embodiment of the invention, the collar is mounted to the battery post before the terminal post is positioned through its corresponding opening in the lid, and in another embodiment the collar may be mounted to the battery post after the post is positioned through its corresponding lid opening.

The present invention overcomes problems caused by concentric misalignment and/or non-uniform force applied to the seal, as well as problems associated with the use of high torque applied to the collar to draw the terminal post and components within the battery case securely up against the lid. With the present invention the seal is located between the collar and strap so that the collar applies a uniform force against the seal. There are no concentricity problems because the collar, which applies the force for the seal, is mounted to the terminal post such that concentricity between these components is insured. Also, the torque applied to the collar need be only sufficient to effect a seal between the collar and strap.

### BRIEF DESCRIPTION OF THE DRAWINGS

Further features of the invention are set forth in the following detailed description of the preferred embodiment of the invention including the drawing figures wherein:

FIG. 1 is a perspective view of a battery that employs the terminal structure in accordance with a preferred embodiment of the invention;

FIG. 2 is a top plan view of a portion of the battery of FIG. 1 where the terminals of the invention are mounted;

FIG. 3 is a cross-section of the portion of the battery taken along the line 3-3 shown in FIG. 2;

FIG. 4 is a perspective, disassembled view showing a preferred embodiment of the component parts of the terminals of the invention shown in FIG. 3;

FIG. 5 is a partial side sectioned view showing a preferred embodiment of the construction of the terminal of the invention;

FIG. 6 is view similar to FIG. 5, but showing an alternate preferred embodiment;

FIG. 7 is a view similar to FIG. 5, but showing an alternate preferred embodiment;

FIG. 8 is a view similar to FIG. 5, but showing an alternate preferred embodiment;

FIG. 9 is a view similar to FIG. 5, but showing an alternate preferred embodiment;

FIG. 10 is a view similar to FIG. 5, but showing an alternate preferred embodiment;

FIG. 11 is a view similar to FIG. 5, but showing an alternate preferred embodiment;

FIGS. 12A and 12B show a heat seal structure for securing the lid to the box and collar in accordance with a preferred embodiment of the invention; and

FIG. 13 is a view similar to FIG. 3, but showing an alternate preferred embodiment.

FIG. 14 is a view similar to FIG. 3, but showing an alternate preferred embodiment.

### DETAILED DESCRIPTION OF THE PREFERRED EMBODIMENT

With reference to the drawings, there is shown a battery 10 in accordance with a preferred embodiment of the invention. The battery 10 has a casing comprising a battery box 12 and a lid 14. The casing is constructed of materials typically employed in the construction of battery casings and particularly batteries of the lead-acid type to which the present invention is primarily directed. The battery box 12 has a rectangular top edge 16 that surrounds a top access opening into the battery box interior 18. The lid 14 has a rectangular configuration that is dimensioned to fit over the battery box top edge 16.

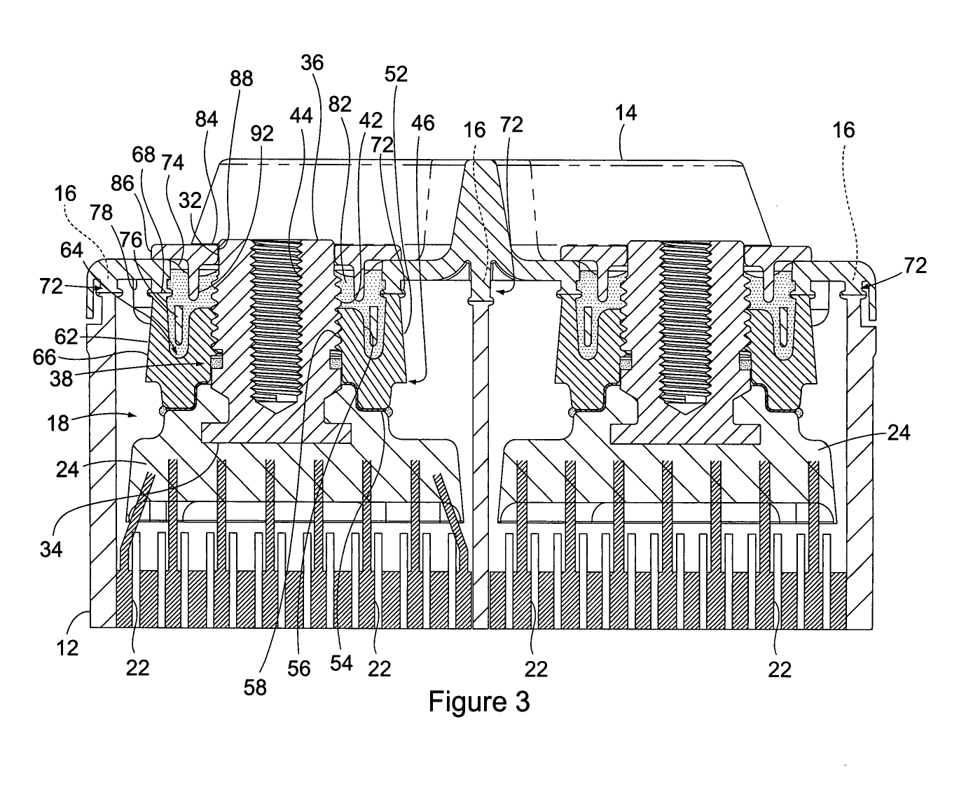

A plurality of battery plates 22 are contained in the battery box interior 18, as shown in FIG. 3. The plates 22 of like polarity are interconnected by a lead or lead alloy plate strap 24 as is conventional in the lead-acid battery art. Battery acid is contained within the plates and the interior of the casing as is also conventional with a lead-acid battery.

A preferred embodiment of a terminal structure of the invention is shown in the cross-section view of FIG. 3. The two electric terminal structures shown in FIG. 3 are identical in construction. The terminal structure includes a post 32 that is constructed of an electrically conductive metal, preferably brass. The post 32 has a length with opposite proximal 34 and distal 36 ends. The post proximal (base) end 34 is generally T-shaped in cross-section as shown in FIG. 3 and preferably is cast into the strap 24 by a “cast-on-strap” (COS) process well known in the art, such that the base of the terminal is soldered and solidly anchored in the strap. The post exterior surface is generally cylindrical. An annular groove 38 is formed into the post exterior surface adjacent the connection to the plate strap 24. Above the groove 38, the post exterior surface is formed with external screw threading 42 that extends upwardly from the groove 38 to adjacent the post distal end 36. It should be noted that whether the groove 38 is present depends on the type of threads that are used. Where “roll” threads are used, the groove is not required. A center bore with internal screw threading 44 extends downwardly into the post from the post distal end 36 and serves as a means for connecting a device to the battery terminal to provide electrical power to the device.

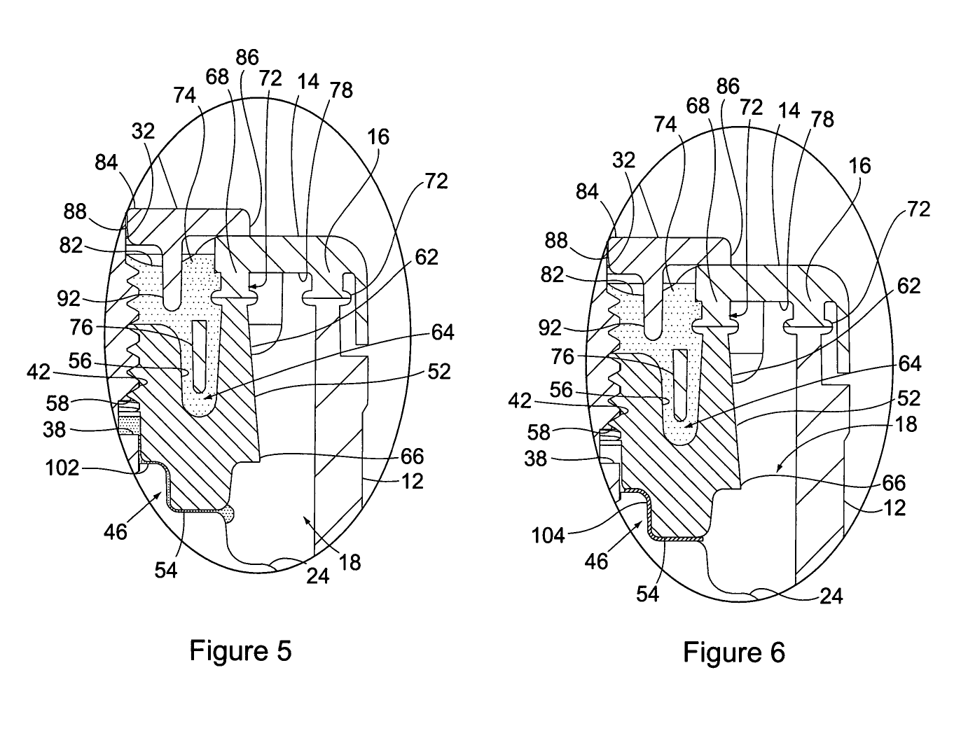

An annular seal 46 is positioned around the terminal post 32. In various embodiments of the terminal construction of the invention, different types and configurations of seals 46 are employed. For example, the seal 46 may be a sealant. As used herein, “sealant” means a material which when applied is in a fluidized condition, and, whether settable or non-settable, has the property of providing an effective seal against leakage of the acid within the battery. In a preferred embodiment a suitable sealant may be Loctite Untra Blue RTV Silicone Gasket Maker. In another embodiment, the seal is provided by a gasket, which may be, but is not required to be, of an elastomeric material, positioned around the terminal and held in compression between the collar and the plate strap. In a further embodiment, the seal is provided by a grommet positioned around the terminal and between the collar and the plate. Examples of the various types of seals 46 that may be employed in the terminal construction of the invention will be described with reference to FIGS. 5-11.

A cylindrical collar or nut 52 is mounted on the exterior surface of the terminal post 32. The collar 52 is constructed of a material that is inert to the environment within the battery casing and that can be secured to the casing lid. Preferably the collar material also is electrically non-conductive; for example, a plastic. The collar preferably is of a molded, one-piece, construction, but could also be a machined part.

The collar 52 is constructed with an annular bottom wall 54 that in the embodiment of FIGS. 3, 5, 6, and 8 is generally S-shaped to conform to a generally S-shaped surface at the top of the plate strap 24 to accommodate the seal 46. The collar 52 has a cylindrical center hub 56. The center hub 56 has a bore hole with internal screw threading 58 that matches the external screw threading 42 of the terminal post 32, enabling the collar 52 to be screw-threaded onto the post 32. The collar 52 is also formed with a cylindrical sleeve 62 that is spaced outwardly from the center hub 56. The spacing of the sleeve 62 defines an annular trough 64 in the top surface of the collar between the center hub 56 and the sleeve 62. The sleeve 62 has an outer surface that defines an outer perimeter surface 66 of the collar 52. Any suitable means may be provided to facilitate turning the threaded collar onto the terminal post. For example, the surface 66 may be knurled, hexagon shaped, or grooved to engage an appropriate tool to turn the collar onto the post. The collar sleeve 62 has a height that extends the sleeve above the center hub 56 to an annular top edge 68 of the sleeve.

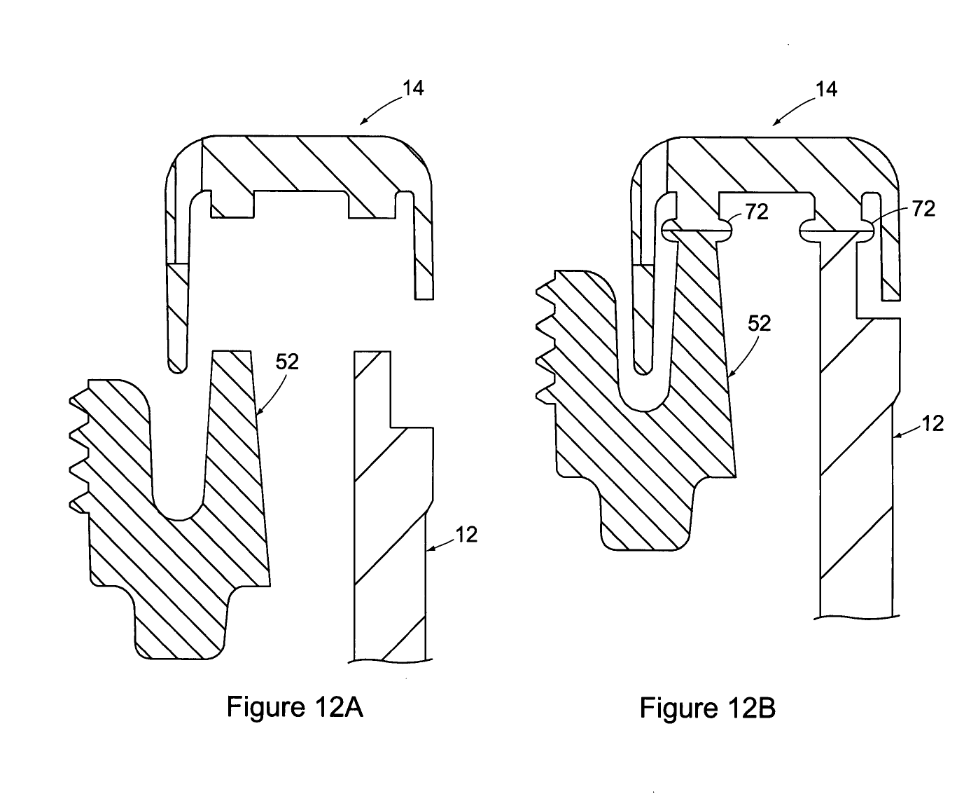

The battery casing lid 14 is positioned over the battery box 12 with a peripheral portion of the lid being structurally sealed to the top edge 16 of the battery box, such that upon sealing the lid to the box the casing so formed becomes a structure of sufficient strength to house and support the various battery components. In preferred embodiments, the peripheral portion of the lid is sealed to the battery box top edge 16 such as by heat sealing, sonic welding, or adhesive (generally designated 72 in FIG. 3). FIGS. 12A and 12B illustrate a preferred embodiment using heat sealing, generally showing the configurations of the collar, lid, and box both before and after these components are heat sealed together.

The lid 14 is provided with a terminal opening defined by a perimeter edge 74 of the opening. An annular rim 76 projects downwardly from an interior surface 78 of the lid at the opening edge 74. As shown in FIG. 3, the lid rim 76 is dimensioned to extend downwardly into the collar annular trough 64. Thus, the annular rim 76 extends around the center hub 56 of the collar 52, and the collar annular sleeve 62 extends around the lid rim 76.

As shown in FIG. 3, the top edge 68 of the collar sleeve 62 is structurally sealed to the lid interior surface 78 around the lid rim 76 such that the lid and collar become rigidly connected. In the preferred embodiment, the collar sleeve top edge 68 is sealed to the lid interior surface 78 by heat sealing, sonic welding, or adhesive (generally designated 72 in the drawing) (see FIGS. 12A and 12B).

To further seal against the escape or leakage of battery acid from the battery casing lid opening, a sealant 82 is applied to the collar trough 64. In the preferred embodiment the sealant 82 is of a settable type and may be an epoxy or an adhesive such as methylmethacrylate. In a preferred embodiment, the epoxy may be Vantico Inc. Two Part Epoxy: Part A-Araldite CY 8763; Part B-Hardener HY 8763. As seen in FIG. 3, the epoxy 82 fills the collar trough 64 with the lid rim 76 extending and embedded into the epoxy. A vertical groove 83 extends along the inner surface of the rim 76 and has openings 83′ that function as air vents to aid in filling the collar trough as the sealant is introduced into the trough.

A decorative circular cap 84 is positioned over the lid opening. The cap 84 has an outer peripheral edge 86 that is larger than the lid opening edge 74. A center hole 88 of the cap is dimensioned to receive the terminal post distal end 36. The cap 84 also has an annular flange 92 that extends downwardly from the cap into the epoxy 82. Thus, upon curing, the sealant 82 holds the cap 84 in position covering the disc-shaped opening between the lid opening edge and the terminal post.

FIGS. 3 and 5-11 show various embodiments of the seal 46 employed with the terminal construction of the invention.

In the embodiment of FIG. 5, the seal 46 is provided by a sealant 102 that is positioned around the terminal post 32. As shown in FIG. 5, an annular layer of the sealant 102 extends into the terminal post annular groove 38 and is sandwiched between the plate strap 24 and collar 52.

FIG. 6 shows a further embodiment in which the seal 46 is provided by an annular gasket 104. With the collar 52 screw threaded down on the terminal post 32, the gasket 104 is sandwiched between the collar 52 and the plate strap 24. The gasket may be of an elastomeric material which may be held in compression at the interface between the collar and strap as illustrated in FIG. 6.

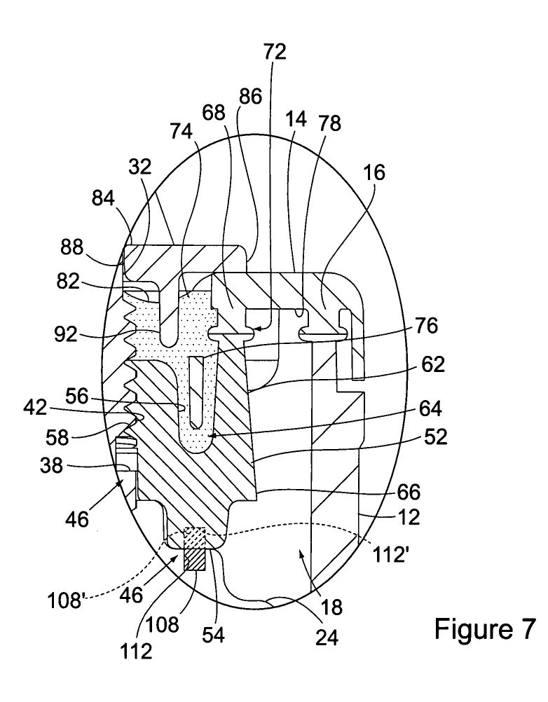

FIG. 7 shows a further embodiment of the seal 46. In FIG. 7, the seal 46 is provided by an annular grommet 108, which may be of an elastomeric material, that extends around the terminal post 32 and is inserted into an annular groove 112 formed in the top surface of the plate strap 24. As an alternative to this arrangement, an annular grommet 108′, which may be of an elastomeric material, may be inserted into an annular groove 112′ formed in the collar bottom surface 54. In either arrangement, with the collar 52 screwed down on the terminal post 32, the grommet 108, 108′ is sandwiched, and preferably held in compression between the collar 52 and the plate strap 24. In a further embodiment represented in FIG. 7, both grommets 108, 108′ can be used.

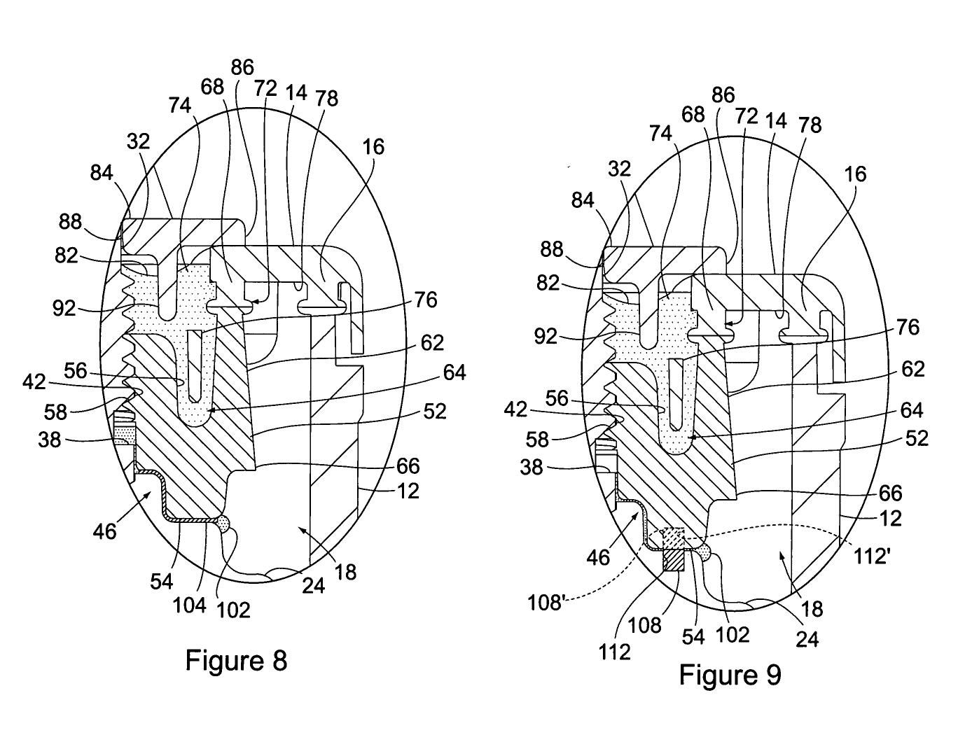

FIGS. 3 and 8 show a further embodiment of the seal 46. Here the seal 46 is provided by a combination of the sealant 102 shown in FIG. 5, and the annular gasket 104 shown in FIG. 6.

FIG. 9 shows a further embodiment of the seal 46. In FIG. 9, the seal 46 is provided by the combination of the sealant 102 shown in FIG. 5, and one or more of the grommets 108, 108′ shown in FIG. 7.

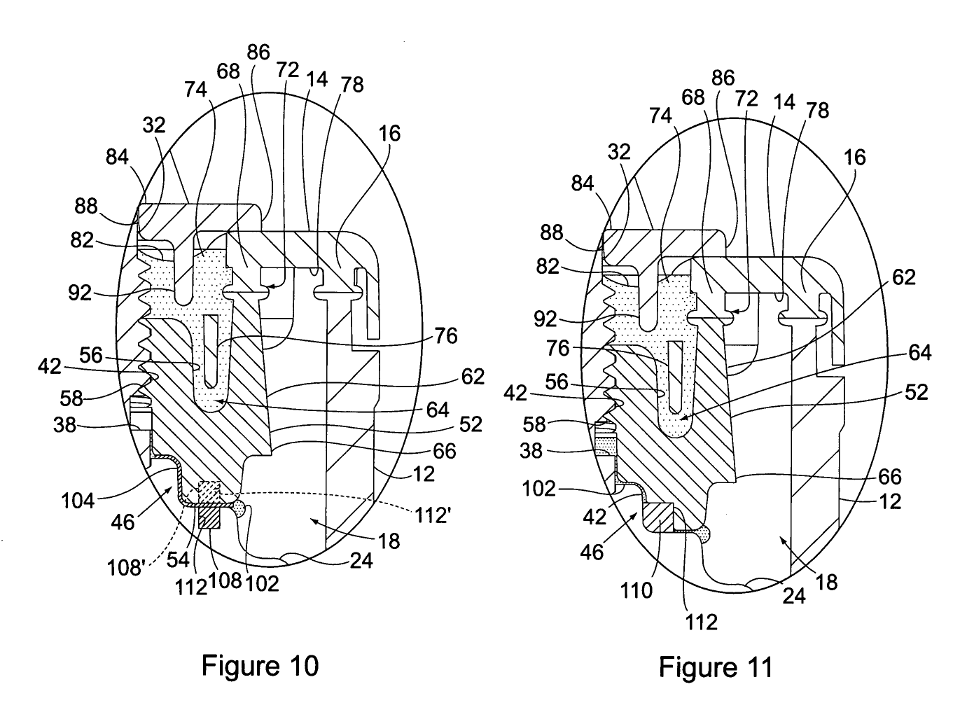

FIG. 10 shows a still further embodiment of the seal 46. In FIG. 10, the seal 46 is provided by the combination of the sealant 102 shown in FIG. 5, the annular gasket 104 shown in FIG. 6, and one or more of the annular grommets 108, 108′ shown in FIG. 7.

FIG. 11 shows another embodiment of the seal 46 where the seal is similar to that of FIG. 5, but with the addition of a grommet 110 placed within an annular recess 112 in the bottom of the collar and sandwiched between the collar and strap. The grommet may be of an elastomeric material held in compression between the collar and strap, and may be used with or without a sealant 102 and in combination with gaskets and grommets of the other embodiments.

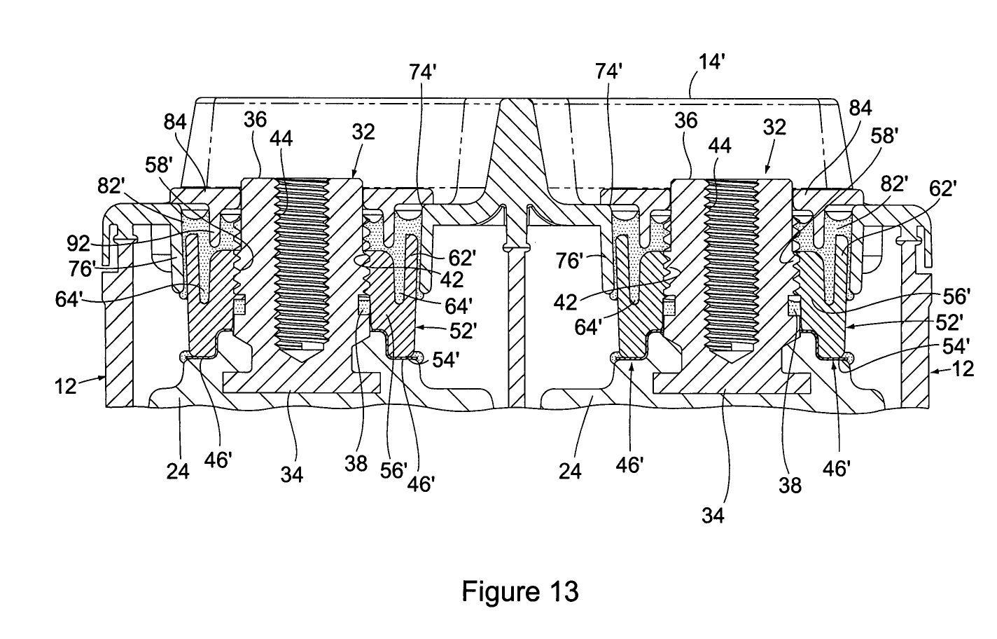

FIG. 13 illustrates an alternate embodiment of the invention where the collar may be mounted to the terminal post after the lid is positioned with the terminal posts extending through the lid openings. Many of the components of this embodiment are the same as with the previously described embodiment as shown by use of the same reference numbers.

The primary differences between the embodiment of FIG. 13 and that of FIG. 3 are in the structures of the collar sleeve 62/62′ and rim 76/76′. As shown in FIG. 13, the rim 76′ is generally straight but angles slightly toward the center of the lid opening. The sleeve 62′ extends upwardly and somewhat outwardly away from the center of the lid opening to extend generally parallel to, and spaced inwardly from, the rim 76′. Thus, there is a small annular space or gap between the outer wall of the sleeve 62′ and the inner wall of the rim 76′. It will be noted that unlike the embodiment of FIG. 3 where the rim 76 extends within the collar trough 64, with this embodiment the rim 76′ is located outwardly of the sleeve 62′. A sealant 82′ fills the annular space defined by the trough 64′ as well as the space above the trough to contact the external threads of the terminal post and the rim 76′ above the sleeve 62′, and also the annular gap between the sleeve 62′ and the rim 76′. In the preferred embodiment the sealant 82′ is of a settable type and may be an epoxy or an adhesive such as methylmethacrylate, and upon setting forms a strong and structurally sound structural bond between the collar sleeve and the rim of the lid. A cap 84 is positioned over the lid opening as with the embodiment of FIG. 3.

It should be understood that the S-shaped configuration of the mating surfaces between the collar and strap are essentially the same as with the embodiment of FIG. 3. Also, the seal 46′ is the same as the seal 46 and may include any of the various previously described embodiments for the seal.

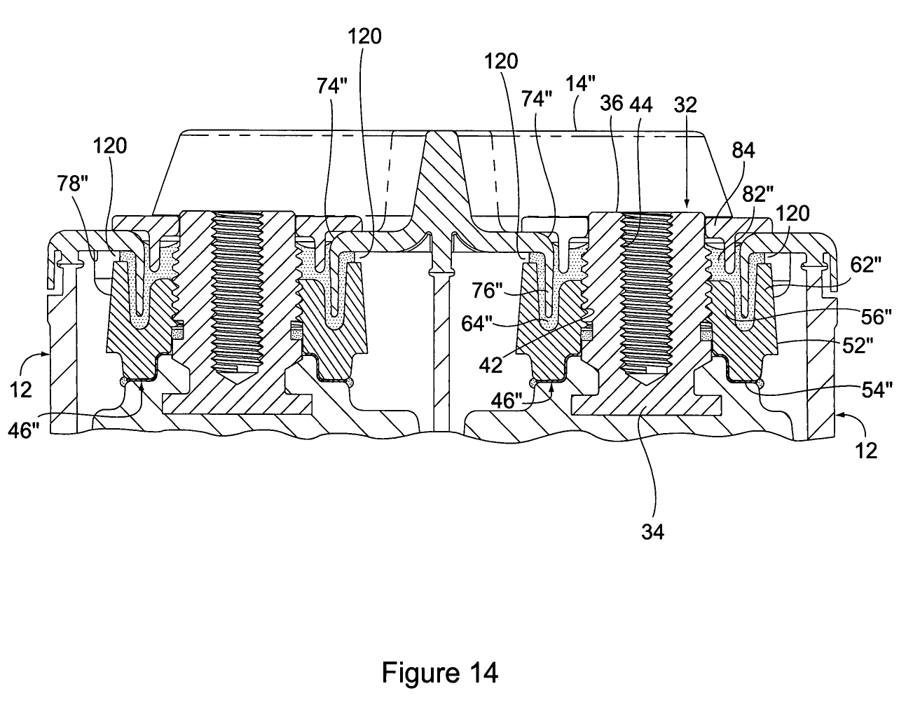

FIG. 14 illustrates an alternate embodiment of the invention. Many of the components of this embodiment are the same as with the previously described embodiment of FIGS. 3 to 12 as shown by use of the same reference numbers.

The primary differences between the embodiment of FIG. 14 and that of FIG. 3 are in the structures of the collar sleeve 62/62″ and rim 76/76″, the manner in which the collar is sealed to the lid, and the manner in which the collar trough 64 is vented.

As shown in FIG. 14, the upper surface of the sleeve 62″ is spaced from the under side of the lid to provide a gap 120 that communicates the space defined by the trough with the interior of the battery. The gap 120 serves to vent the trough to the battery interior to facilitate filling the collar trough upon introducing the sealant 82″ into the trough. The sealant 82″ preferable substantially fills the trough and extends into the gap 120. The rim 76″ is like the rim 76 of FIG. 3, but does not have the vertical groove 83 and vent openings 83′ as the venting for the FIG. 14 embodiment is to the battery interior through the gap 120.

With the FIG. 14 embodiment, the collar is sealed to the lid solely by the sealant 82″. In the preferred embodiment the sealant 82″ is of a settable type and may be an epoxy or an adhesive such as methylmethacrylate, and upon setting forms a strong and structurally sound structural bond between the collar and lid. A cap 84 is positioned over the lid opening as with the embodiment of FIG. 3.

It should be understood that the S-shaped configuration of the mating surfaces between the collar and strap are essentially the same as with the embodiment of FIG. 3. Also, the seal 46″ is the same as the seal 46 and may include any of the various previously described embodiments for the seal.

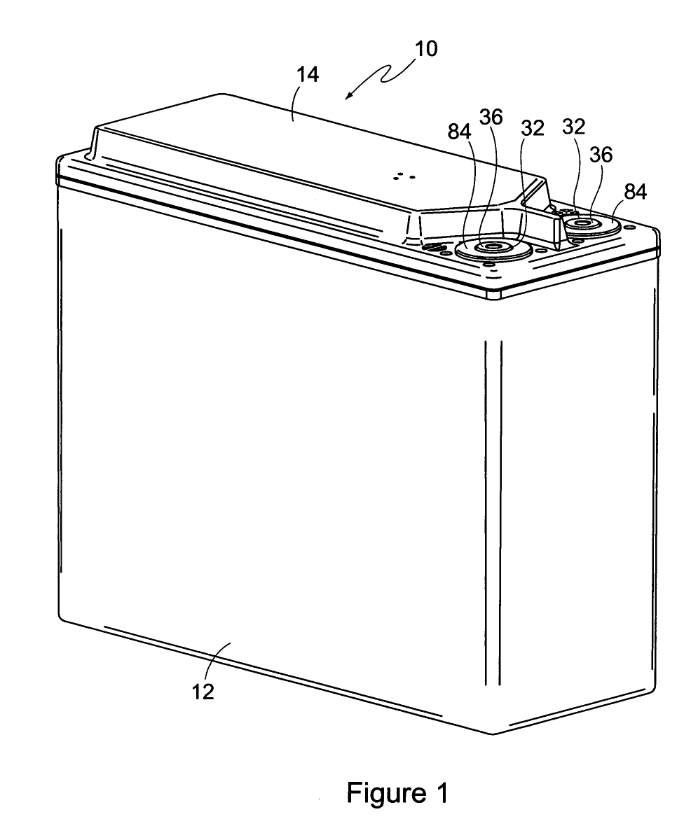

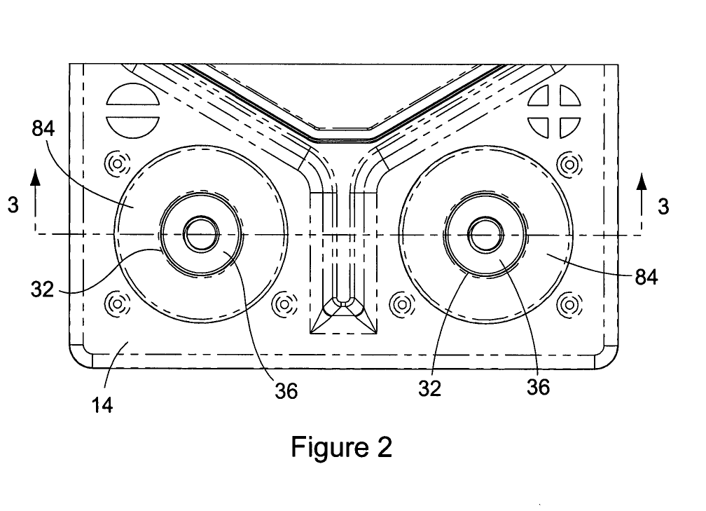

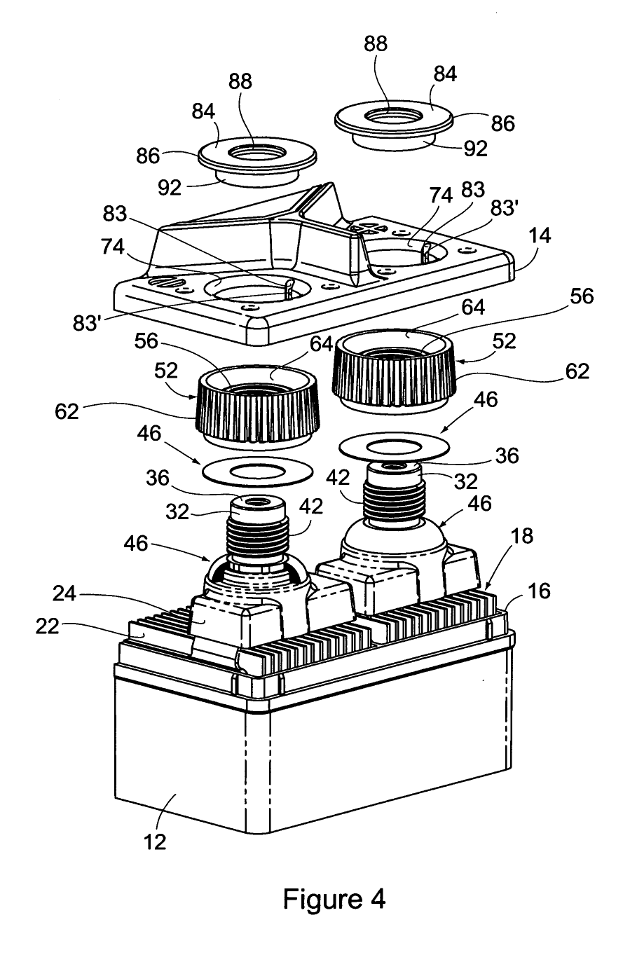

With reference to FIG. 4, to construct or assemble the battery 10 in accordance with the preferred embodiments of the invention as illustrated in FIGS. 1-12, previously assembled battery plates, straps the terminal posts are placed within the box 12 of the casing as shown. A seal 46 is placed around each of the battery terminal posts. This placement of seals 46 around the terminal posts may occur either before or after the pre-assembled plates, straps, and terminal posts are placed into the box. After the seals are in place, the collars 52 are mounted to the terminal posts such that the seals are sandwiched between the collars and straps, and in the case of seals having elastomeric components, preferably such that these components are held in compression. The mounting of the collars may occur either before or after the pre-assembled plates, straps, and terminal posts are places into the box. After the collars are mounted to the terminal posts, the lid 14 is positioned with the terminal posts extending through the openings in the lid, and thereafter is structurally sealed about the openings to the tops of the collar sleeves 62. This may occur either before or after the pre-assembled plates, straps, and terminal posts are placed into the box. After the pre-assembled plates, straps, and terminal posts are placed into the box, and after the collars are mounted to the terminal posts, the lid 14 is structurally sealed to the box to provide a sealed and structurally sound battery casing. The lid may be sealed to the box either before or after the lid is sealed to the collar.

Preferably, after the lid is sealed to the collars, a settable sealant such as an epoxy 82 is introduced into the troughs 64 of the collars so as to surround the lid rims 76 and contact the external threaded portions of the terminal posts above the collars. The sealant 82 may also contact the under side of the lid. The vent openings 83′ serve to vent air to outside the battery case that would otherwise become trapped upon introduction of the sealant 82. Next, before the settable material cures, the decorative caps 84 are placed over the openings in the lid surrounding the terminals with their annular flanges 92 embedded into the settable material to hold the caps in place once the settable material cures.

Assembly of the embodiment of FIG. 13 is the same as that previously described except that with the FIG. 13 embodiment the collars 52′ are mounted on the terminal post after the lid is positioned with the terminal post extending through the lid openings. Alternately, by reducing the flair angles of the collar sleeves 62′ and rims 76′, the collar 52′ may be mounted to the post either before or after the lid is positioned with the terminal posts extending through the lid openings. Also, with the FIG. 13 embodiment, the sealant 82′ itself functions to seal the collars to the lid.

Assembly of the embodiment of FIG. 14 is much the same as that of FIG. 3 except that the sealant 82″ also functions to seal the tops of the sleeves 62″ to the under side of the lid about the openings. Also with the FIG. 14 embodiment, air is vented to within the battery case through the vent opening formed by the gap 120 as the sealant 82″ is introduced.

Thus, it can be appreciated that the battery and battery terminal structure of the invention performs dual sealing functions: to seal against leakage of battery acid past the terminal post and through the terminal openings in the lid or otherwise from the casing, as well as to seal against the battery acid from contacting the terminal and reacting with the material of the terminal or otherwise shortening the expected useful life of the battery. The seal 46 is located in what otherwise would be a leakage path for acid within the battery to reach the terminal. The sealing of the collars to the lid, blocks any path that the acid otherwise would have for the acid to leak to the exterior of the casing. The settable sealant 82 provides a further seal to prevent leakage of the battery acid past the collar.

While the present invention has been described by reference to specific embodiments, it should be understood that modifications and variations of the invention may be constructed without departing from the scope of the invention defined in the following claims:

1) an electrically conductive terminal structure comprising:
an electrically conductive post having a length with an exterior surface extending between opposite proximal and distal ends of the post;
a casing around the post, the casing having an opening and the post being positioned in the casing opening; and
a collar on the post exterior surface, at least a portion of the collar being inside the casing adjacent the casing opening, the collar engaging with the casing and being sealed to the casing.

2) The terminal of claim 1, further comprising:
the collar being heat sealed to the casing.

3) The terminal of claim 1 further comprising:
the collar being sonic welded to the casing.

4) The terminal of claim 1 further comprising:
the collar being adhesively sealed to the casing.

5) The terminal of claim 1, further comprising:
the casing having a perimeter edge that extends around the casing opening; and
the collar having an outer perimeter surface that extends outside the casing perimeter edge.

6) The terminal of claim 5, further comprising:
the casing having an interior surface that encloses an interior volume of the casing; and
the collar engaging with and being sealed to the casing interior surface.

7) The terminal of claim 1, further comprising:
the post having screw threading on the post exterior surface; and
the collar having internal screw threading engaging around the screw threading of the post.

8) The terminal of claim 1, further comprising:
an electrical component in the casing, the electrical component being connected to the post proximal end; and
a seal around the post, the seal being sandwiched between the collar and the electrical component.

9) The terminal of claim 8:
the seal comprising an elastomeric member held in compression between the collar and electrical component.

10) The terminal of claim 8, further comprising:
the seal comprising a grommet.

11) The terminal of claim 8, further comprising:
the seal comprising a combination of a grommet and a sealant that both extend around the post.

12) The terminal of claim 8, further comprising:
the seal comprising a sealant that extends around the post.

13) The terminal of claim 8, further comprising:
the seal comprising a gasket that extends around the post.

14) The terminal of claim 8, further comprising:
the seal comprising a combination of a gasket and a sealant that both extend around the post.

15) An terminal of claim 8, further comprising:
the seal comprising a combination of a grommet, a sealant, and a gasket that all extend around the post.

16) The terminal of claim 1, further comprising:
the casing comprising a battery box and the post being a battery terminal.

17) The terminal of claim 1, further comprising:
the collar having a center hub that engages around the post and the collar having a sleeve that extends around the center hub; and
the casing having a rim that extends around the casing opening and extends around the post.

18) The terminal of claim 17, further comprising:
the rim extending around the collar hub; and
the collar sleeve extending around the rim.

19) The terminal of claim 18, further comprising:
a sealant inside the collar tubular sleeve; and
the lid rim embedded into the sealant.

20) An electrically conductive terminal structure comprising:
an electrical component;
an electrically conductive post having a length with an exterior surface extending between opposite proximal and distal ends of the post, the post proximal end being electrically connected to the electrical component;
a seal extending around the post;
a collar mounted on the post and engaging with the seal,
a casing having an interior containing the electrical component, at least a portion of the post, the seal, and at least a portion of the collar; and
a lid on the casing covering over the electrical component, at least a portion of the post, the seal, and at least a portion of the collar.

21) The terminal of claim 20, further comprising:
the seal being sandwiched between the electrical component and the collar.

22) The terminal of claim 20 wherein:
the seal comprising an elastomeric member held in compression between the collar and electrical component.

23) The terminal of claim 21, further comprising:
the seal comprising a grommet that extends around the post.

24) The terminal of claim 21, further comprising:
the seal comprising a combination of a grommet and a sealant that both extend around the post.

25) The terminal of claim 21, further comprising:
the seal comprising a sealant that extends around the post.

26) The terminal of claim 21, further comprising:
the seal comprising a gasket that extends around the post.

27) The terminal of claim 21, further comprising:
the seal comprising a combination of a gasket and a sealant that both extend around the post.

28) The terminal of claim 21, further comprising:
the seal comprising a combination of a grommet, a sealant, and a gasket that all extend around the post.

29) The terminal of claim 20, further comprising:
the post having screw threading on the post exterior surface; and
the collar having internal screw threading engaging with the post screw threading whereby the collar can be adjustably positioned along the post length to sandwich the seal between the electrical component and the collar.

30) The terminal of claim 20, further comprising:
the lid having an opening and the post extending through the opening.

31) The terminal of claim 20, further comprising:
the electrical component comprising a plate strap of a lead-acid battery.

32) The terminal of claim 30, further comprising:
the collar having a center hub that engages around the post and the collar having a sleeve that extends around the center hub; and
the lid having a rim that extends around the opening and the post.

33) The terminal of claim 32, further comprising:
the lid rim extending around the collar hub; and
the collar sleeve extending around the lid rim.

34) The terminal of claim 32, further comprising:
a sealant inside the collar sleeve; and
the lid rim embedded into the sealant.

35) A battery structure comprising:
a box having an interior;
an electrical component contained in the box interior;
an electrically conductive post having a length with an exterior surface extending between opposite proximal and distal ends of the post, the post proximal end being secured to the electrical component with the post projecting from the electrical component to the post distal end;
a seal extending around the post;
a collar mounted on the post; and
a lid mounted on the box enclosing the box interior with at least a portion of the collar enclosed in the box interior and exposed to the environment in the box interior.

36) The battery of claim 35, further comprising:
the electrical component being a plate strap of a lead-acid battery.

37) The battery of claim 36 further comprising:
the collar being of a material that is inert to the environment within the battery.

38) The battery of claim 35, further comprising:
the lid having an opening and the post extending through the lid opening.

39) The battery of claim 38, further comprising:
the collar having a center hub that engages around the post and the collar having a sleeve that extends around the center hub; and
the lid having a rim that extends around the lid opening and the post.

40) The battery of claim 39, further comprising:
the lid rim extending around the collar hub; and
the collar sleeve extending around the lid rim.

41) The battery of claim 39, further comprising:
a sealant inside the collar sleeve; and
the lid rim embedded into the sealant.

42) The battery of claim 39, further comprising:
the collar sleeve being secured to the lid around the lid opening.

43) The battery of claim 35, further comprising:
the collar being sealed to the lid.

44) The battery of claim 35, further comprising:
the seal being sandwiched between the electrical component and the collar.

45) The battery of claim 44:
the seal comprising an elastomeric member held in compression between the collar and electrical component.

46) The battery of claim 44, further comprising:
the seal comprising a grommet that extends around the post.

47) The battery of claim 44, further comprising:
the seal comprising a combination of a grommet and a sealant that both extend around the post.

48) The battery of claim 44, further comprising:
the seal comprising a sealant that extends around the post.

49) The battery of claim 44, further comprising:
the seal comprising a gasket that extends around the post.

50) The battery of claim 44, further comprising:
the seal comprising a combination of a gasket and a sealant that both extend around the post.

51) The battery of claim 44, further comprising:
the seal comprising a combination of a grommet, a sealant, and a gasket that all extend around the post.

52) The battery of claim 44, further comprising:
the post having screw threading on the post exterior surface; and
the collar having internal screw threading engaging with the post screw threading whereby the collar can be adjustably positioned on the post to sandwich the seal between the electrical component and the collar.

53) A method of constructing a lead acid battery comprising, in no required order unless specified:
providing a battery box with a top opening to an interior of the battery box;
providing a lid for covering the top opening;
placing pre-assembled battery plates, strap and terminal post in the battery box, the strap electrically connecting plates of like polarity, the post being mounted to the plate strap with the post projecting from the plate strap;
placing a seal around the post;
sealing the collar to the lid; and
after placing the seal around the post, mounting a collar on the post with the seal sandwiched between the plate strap and the collar.

54) The method of claim 53:
the seal around the post comprising an elastomeric member held in compression between the collar and electrical component.

55) The method of claim 53;
the seal around the post comprising a sealant.

56) The method of claim 53, further comprising:
providing the collar with a center hub and a sleeve that extends around the center hub, and mounting the center hub on the terminal post and sealing the sleeve to the lid.

57) The method of claim 53, further comprising:
providing the collar with a center hub and a sleeve that extends around the center hub;
mounting the center hub on the terminal post;
providing the lid with an opening; and
mounting the lid on the battery box with the terminal post positioned in the lid opening.

58) The method of claim 53, the lid having an opening, the method further comprising:
positioning the lid with the post extending through the opening after mounting the collar to the post.

59) The method of claim 53, the lid having an opening, the method further comprising:
positioning the lid with the post extending through the opening before mounting the collar to the post.

60) The method of claim 56, the lid having an opening, the method further comprising:
providing a rim on the lid interior surface around the lid opening; and,
inserting the rim into the sleeve when mounting the lid on the battery box.

61) The method of claim 60, further comprising:
injecting a settable sealant inside the collar sleeve, the lid rim projecting into the sealant with the lid mounted on the battery box.

62) The method of claim 61, further comprising:
mounting a cap over the lid opening with a portion of the cap projecting into the settable sealant.

63) The method of claim 53, further comprising:
providing screw threading on the terminal post exterior surface;
providing the collar with internal screw threading that mates with the terminal post screw threading; and
screwing the collar down on the terminal post thereby sandwiching the seal between the collar and the plate strap.

64) The method of claim 63 wherein:
the seal comprising an elastomeric member held in compression between the collar and electrical component.

65) The method of claim 53, further comprising:
positioning a grommet around the post as the seal around the post.

66) The method of claim 53, further comprising:
positioning a grommet around the post in combination with a sealant around the post as the seal around the post.

67) The method of claim 53, further comprising:
positioning a sealant around the post as the seal around the post.

68) The method of claim 53, further comprising:
positioning a gasket around the post as the seal around the post.

69) The method of claim 53, further comprising:
positioning a gasket around the post in combination with a sealant around the post as the seal around the post.

70) The method of claim 53, further comprising:
positioning a gasket around the post, positioning a grommet around the post, and positioning a sealant around the post as the seal around the post.

71) A battery of the lead-acid type comprising:
a battery box;
a plurality of battery plates electrically connected by a battery strap, the plates and strap positioned within the box;
a terminal post mounted to the strap;
a collar mounted on the post;
a seal around the post between the collar and the strap;
a lid mounted to the battery box;
the seal being out of contact with the lid.

72) The battery of claim 71, wherein the lid is sealed to the collar.

73) The battery of claim 72 wherein the collar is of a material that is inert to the environment within the battery.

74) The battery of claim 73 wherein the collar is mounted to the post with engaging threads.

75) The battery of claim 74 wherein the seal comprises an elastomeric member held in compression between the collar and strap.

76) The battery of claim 74 wherein the seal comprises a sealant sandwiched between the collar and strap.

77) The battery of claim 74 wherein the seal comprises a sealant and an elastomeric member, the elastomeric member being held in compression between the collar and strap.

78) A battery of the lead-acid type comprising:
a battery box;
a plurality of battery plates electrically connected by a battery strap, the plates and strap positioned within the box;
a terminal post mounted to the strap;
a collar mounted on the post;
a seal around the post between the collar and the strap;
a lid mounted to the battery box;
at least a portion of said collar being in contact with the environment within the interior of the battery.

79) The battery of claim 78, wherein the lid is sealed to the collar.

80) The battery of claim 78 wherein the collar is of a material that is inert to the environment within the battery.

81) The battery of claim 80 wherein the collar is mounted to the post with engaging threads.

82) The battery of claim 81 wherein the seal comprises an elastomeric member held in compression between the collar and strap.

83) The battery of claim 81 wherein the seal comprises a sealant sandwiched between the collar and strap.

84) The battery of claim 81 wherein the seal comprises a sealant and an elastomeric member, the elastomeric member being held in compression between the collar and strap.

85) A battery of the lead-acid type comprising:
a battery case including a box having a top opening and a lid overlying the opening;
a plurality of battery plates electrically connected by a battery strap, the plates and strap positioned within the case;
a terminal post mounted to the strap;
a collar mounted on the post;
a seal around the post between the collar and the strap;
a settable sealant introduced at the top side of the collar in contact with the collar and an upper portion of the terminal post, and a vent for venting the air upon introduction of the sealant.

86) The battery of claim 85 wherein the vent vents the air to outside the battery case.

87) The battery of claim 85 wherein the vent vents the air to within the battery case.

88) The battery of claim 86 wherein the collar has a center hub that engages around the post and a sleeve that extends around the center hub, the hub and sleeve defining a cavity;
the lid having a rim that extends around the lid opening and into the cavity;
the vent further comprising at least one opening in the rim.

89) The battery of claim 87 the collar has a center hub that engages around the post and a sleeve that extends around the center hub, the hub and sleeve defining a cavity;
the lid having a rim that extends around the lid opening and into the cavity;
the vent further comprising at least one opening between the sleeve and the lid.

90) The battery of claim 85 wherein the sealant introduced at the top side of the collar is in contact with the collar, an upper portion of the terminal post, and the lid.
